(19) United States
(12) Patent Application Publication
(10) Pub. No.: US 2003/0115578 A1
(43) Pub. Date: Jun. 19, 2003

(54) PC platform simulation system employing efficient memory access simulation in a direct execution environment

(76) Inventors: Igor Liokumovich, Natanya (IL); Rinat Rappoport, Haifa (IL); Roman Fishtein, Haifa (IL); Konstantin Levit-Gurevich, Kiryat Byalik (IL)

Correspondence Address: FISH & RICHARDSON, PC, 4350 LA JOLLA VILLAGE DRIVE, SUITE 500, SAN DIEGO, CA, 92122, US

(21) Appl. No.: 10/025,217

(22) Filed: Dec. 18, 2001

(51) Int. Cl. G06F 9/45

(52) U.S. Cl. 717/138

(57) ABSTRACT

A system and method of simulating a PC platform are disclosed. The PC platform includes a CPU, a chipset, memory and IO devices. The machine instructions of a target CPU are simulated by several simulation modules. The simulation modules include a monitor that translates the machine instructions into translated code and performs virtualization of the target CPU state. The monitor protects the translated code by using a segmentation mechanism. The simulation modules also include a virtual machine that executes the translated code, and a kernel that detects exceptions occurring in the virtual machine and transfers control between the virtual machine and the monitor according to a type of the exceptions. Most of the simulated instructions, including those that access the memory, are executed directly to achieve high simulation speed.

### TECHNICAL FIELD

This invention relates to PC (Personal Computer) platform simulation that employs direct execution and virtualization to allow efficient memory access simulation.

### BACKGROUND

The instruction set architecture (ISA) of a new CPU (Central Processing Unit) is often developed on a simulator before a prototype of the CPU is built. A user can evaluate the instruction set architecture by executing benchmarks on a host machine that runs the simulator. Based on the results produced by the simulator, a user can verify or modify the new CPU design accordingly.

The simulator can be expanded to simulate the behavior of an entire PC platform, including buses and I/O devices. Therefore, a possible benchmark for such a simulator may be an Operating System (OS) (called “Simulated OS” or “Guest OS”).

The simulators that employ binary translation translate each instruction of the benchmark into a sequence of instructions of the host CPU. If the simulated CPU (i.e., the new CPU or the target CPU) and the host CPU architectures are identical or close, the target CPU instructions do not require translation, i.e. the simulated instructions can be executed natively (i.e., directly).

However, most operating systems for personal computers assume full control over the PC. Thus, if the simulated OS is allowed to run natively it will conflict with the host OS (i.e., the OS running on the host PC) over PC resources. Thus the instructions that access the memory or IO devices still require an address transformation.

On the other hand, a key condition for achieving good performance in ISA simulation is the efficient simulation of memory accesses, efficient address transformation scheme. In optimal case, the simulated CPU should be able to access the simulated memory without performing any address transformations.

In order to resolve the conflict, the actions of the simulated OS are controlled. Only the instructions that do not compromise the integrity of the host OS are allowed to run natively. Instructions that access the privileged system state are intercepted and emulated in simulator. A very efficient memory management scheme (based on segment virtualization) is put in place in order to allow instructions that access memory to run natively (with minimal management overhead).

### DESCRIPTION OF DRAWINGS

FIG. 1 is a block diagram of a simulation environment that runs on a host PC platform;

FIGS. 2A, 2B, and 2C show three possible locations for a simulated data segment in a guest linear memory;

FIGS. 3A and 3B show two examples for virtualization of data segments that correspond to FIG. 2B and FIG. 2C, respectively;

FIG. 4 shows that the data segment of FIG. 2C can be replaced by a snare page; and

FIG. 5 is a flow diagram of a virtualization algorithm that processes the situations of FIGS. 2A, 2B, and 2C.

Like reference symbols in the various drawings indicate like elements.

### DETAILED DESCRIPTION

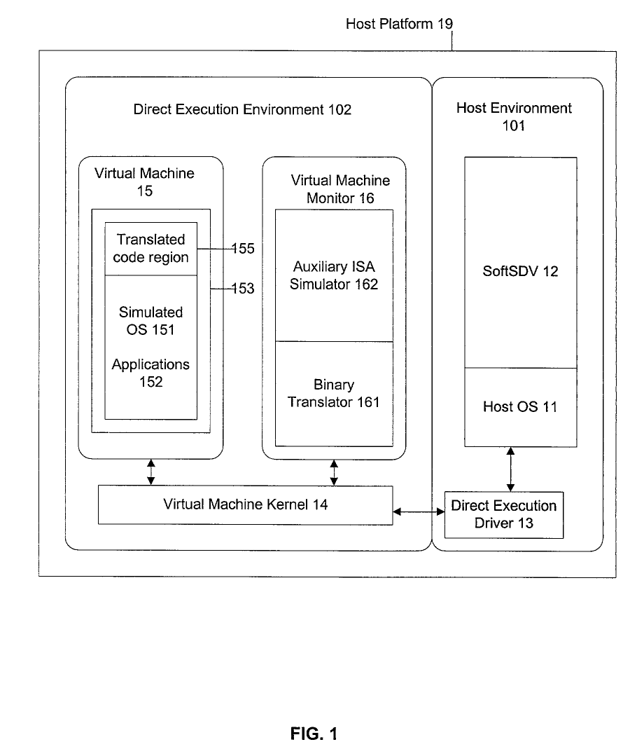

FIG. 1 shows a simulation environment running on top of a host platform 19. The simulation environment includes a host environment 101 and a direct execution environment 102. Both the host environment 101 and the direct execution environment 102 can be implemented entirely in software.

The host environment 101 includes a host OS 11 and a full-platform simulator called SoftSDV (SOFTware-based Software Development Vehicle) 12. The SoftSDV 12 is a software simulator that simulates a PC hardware platform. The host environment 101 also includes a Direct Execution Driver 13, which serves as a gate between the host environment 101 and the direct execution environment 102.

A user invokes the SoftSDV 12 in the host environment to execute a simulated OS 151 code. The SoftSDV 12 then passes simulation control to the direct execution environment 102 where the target CPU is simulated. When the target CPU accesses the simulated devices, the direct execution environment 102 passes simulation control back to the SoftSDV 12. After handling the simulated device access, the SoftSDV 12 again passes simulation control back to the direct execution environment 102.

The direct execution environment 102 includes a virtual machine kernel (VMK) 14, a virtual machine (VM) 15, and a virtual machine monitor (VMM) 16. The VM 15 represents the target CPU. The simulated OS 151 code runs in the VM 15. Most of the simulated instructions are executed directly (i.e., natively) on the host CPU. Those simulated instructions that access CPU system state, e.g., control registers, are intercepted and simulated in the VMM 16. Such instructions are called “sensitive instructions”. The VMM 16 monitors the VM 15 execution, and it provides the simulated OS 151 an illusion that the simulated OS controls all the platform resources.

The VM 15 and the VMM 16 reside in distinct address spaces. The VMK 14 is responsible for switching between these address spaces each time the simulation control is passed back and forth between the VM 15 and the VMM 16, and thus is mapped into both address space of the VM 15 and the VMM 16.

The VM 15 and the VMM 16 run at privilege level 3 (user privilege level), whereas the VMK 14 runs at privilege level 0 (system privilege level). Running the VM 15 at the lower privilege level is called de-privileging and is intended to facilitate interception of sensitive instructions. The VMK 14 is responsible for catching all exceptions, software interrupts, and hardware interrupts occurring in the VM 15 and in the VMM 16. When a hardware interrupt (which is triggered by a device on the host platform) occurs, the VMK 14 passes control to the host OS 11 for handling this interrupt. The VMK 14 forwards all exceptions and software interrupts coming from the VM 15 to the VMM 16 for handling. The exceptions that occur in the VMM 16 cause the simulation to fail.

Before passing execution control to the VM 15, the VMM 16 performs some preliminary processing. A binary translation unit 161 in the VMM 16 scans the code to be simulated and creates translated code that will be executed in the VM 15. Simulated instructions that can be executed natively are copied as is to the translated code.

A sensitive instruction is translated into a sequence of pre-determined, simple instructions, called a “capsule”. Simple sensitive instructions are emulated completely in the VM 15. Complex sensitive instructions are translated to a capsule that causes an exit from the VM 15 to the VMM 16. The VMM 16, after receiving the control, invokes an auxiliary ISA simulator 162 to simulate the original complex sensitive instruction. The linear address space of the VM 15 is constructed in a way that closely resembles the address space intended by the simulated OS 151. Thus, the instructions that access memory can do so natively using the original address. The only exception is the region in the upper part of the VM 15 linear address space, where the VMM 16 locates the translated code. This region is called a “translated code region” 155.

When the VM 15 obtains the execution control back, the VM executes the translated code. Since the highest addresses of VM's 15 linear address space are occupied by the translated code, memory access by the directly executed instructions to this region should be forbidden. Such memory access is intercepted by using a segmentation mechanism.

Segmentation provides a mechanism for dividing the processor's linear address space into smaller protected regions called “segments”. Segments can be used to hold the code, data, and stacks for a program, or to hold system data structures. Creating segments is a responsibility of an OS. The OS defines its segments by assigning a segment base 31, a segment limit, and different segment attributes, e.g., type, granularity, DPL (Descriptor Privilege Level). In order to access memory, programs provide an offset within a segment. The CPU calculates the linear address by adding the offset to a segment base, and checks all protection conditions. If the obtained linear address exceeds the maximum linear address within the segment (segment base plus segment limit), the processor generates a general-protection fault. The CPU holds the attributes of currently used segments in segment registers. The CPU loads the segment registers from a special table called the “descriptor table”. Each entry in this table describes segment attributes, which are packed in a special format called “descriptor”.

The VMM 16 maintains the descriptor tables used by the VM 15. Before passing execution control to the VM 15, the VMM 16 prepares the descriptor values for the code and data segment, and copies the values into a descriptor table used by the VM 15. This process is called the “process of virtualization of segment registers” or simply “virtualization”. The values that are loaded into the segment registers are the values generated by the VMM 16. These values, called the “virtualized” values, will be actually used by the VM 15.

The virtualized values of the segment registers are different from the original values generated by the simulated OS 151. The code segment used in the VM 15 has a base and size equal to the translated code region's 155 base and size. This segment is fully virtualized because its virtualized values do not depend on the original values of the original code segment. The VMM 16 tracks changes in the original code segment by translating all simulated instructions changing the code segment into a capsule that causes an exit from the VM 15 to the VMM 16.

Since the code segment is fully virtualized, all attempts to perform memory access through the code segment should be intercepted. Thus all the instructions that have a code segment override prefix are detected by the VMM 16 during the code translation stage, and replaced with a capsule that causes an exit from the VM 15 to the VMM 16. The VMM 16 will simulate these instructions in the auxiliary ISA simulator 162 to avoid the translated code region from being accessed.

In contrast to code segment registers, the virtualized value of the data segment registers depends on the original value of the Guest data segments. The simulated OS 151 assigns a segment base address, a segment limit, and segment's attributes. Since the simulated OS 151 is not aware of the existence of the translated code, the original data segment may partially overlap with or entirely fall within the translated code region 155.

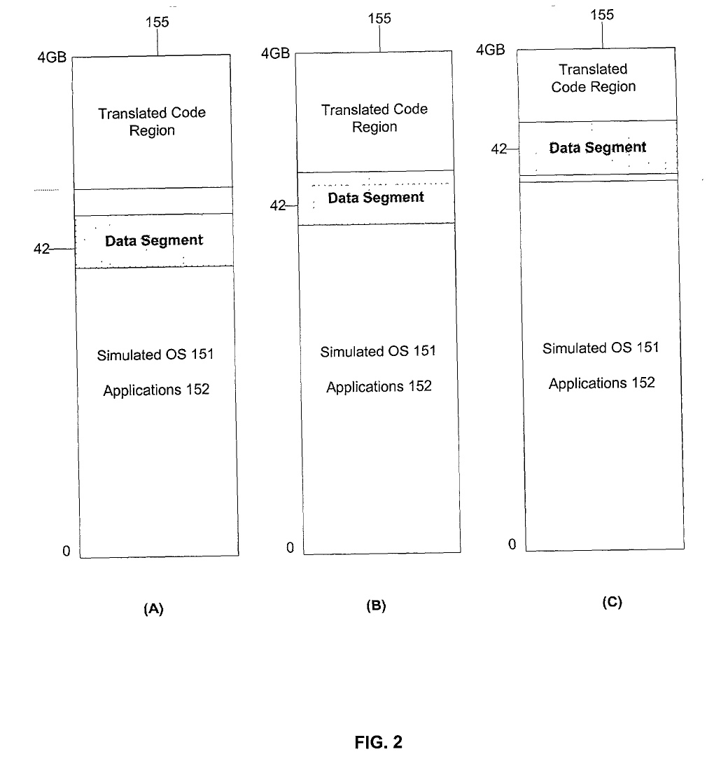

FIGS. 2A, 2B, and 2C illustrate three possible locations of a data segment in a simulated memory 153 with respect to whether or not the data segment overlaps with the translated code region 155. The three possibilities include no overlapping (FIG. 2A), partially overlapping (FIG. 2B), and entirely overlapping (FIG. 2C). If an instruction requires a particular data item in a data segment, the operand of the instruction indicates the location of that data item by supplying an offset to the data segment's base. However, accessing the data segment, in the situations shown in FIGS. 2B and 2C may corrupt the translated guest code. Such access should be intercepted to protect the translated guest code from corruption.

An expand-up segment is a segment that spans upwards from its base up to its limit. If one of the original data segments is an expand-up segment, and it does not overlap with the translated code region 155, a virtualization algorithm, as will be described in detail below, will simply change the descriptor privilege level to support guest de-privileging and leave the rest of the attributes unchanged.

If one of the original data segments is an expand-up segment, and it partially overlap with the translated code region 155, the virtualization algorithm will cut its segment limit so that the limit will not exceed the translated code region base. The VMM 16 compares the boundaries of the data segment with the base of the translated code region 155. If a portion of the data segment overlaps with the translated code region 155, as in the example shown in FIG. 2B, the VMM 16 will modify the original values in descriptor table to prevent the translated code region 155 from being accessed. Specifically, the VMM 16 will set the virtualized segment limit to be the difference between the translated code region base and the original segment base. Any attempt by the translated code to access the linear address above the translated code region base causes a general-protection fault, and the execution control is passed to the VMM 16, which invokes the auxiliary ISA simulator 162 to simulate the original instruction that caused the fault.

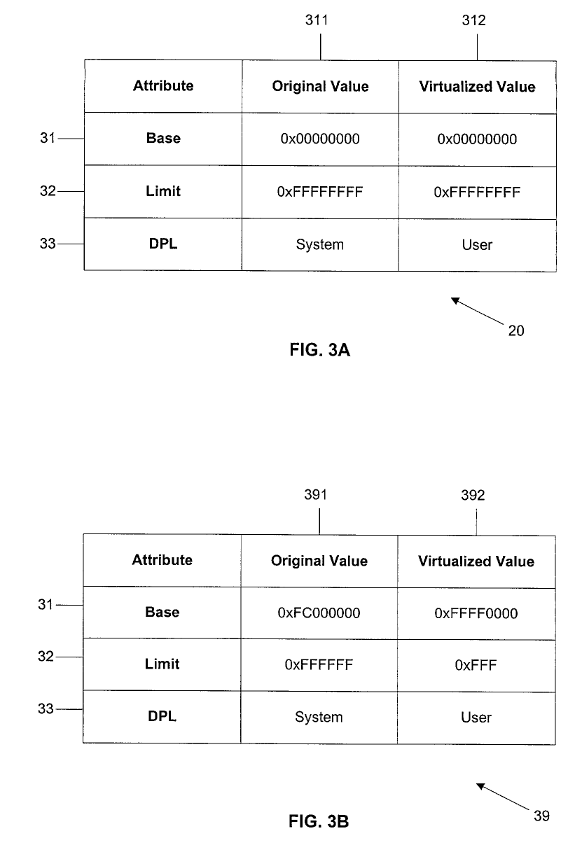

FIG. 3A shows an example of the virtualization of an expand-up data segment. This example assumes that translated code region 155 is based at the linear address 0xF0000000.

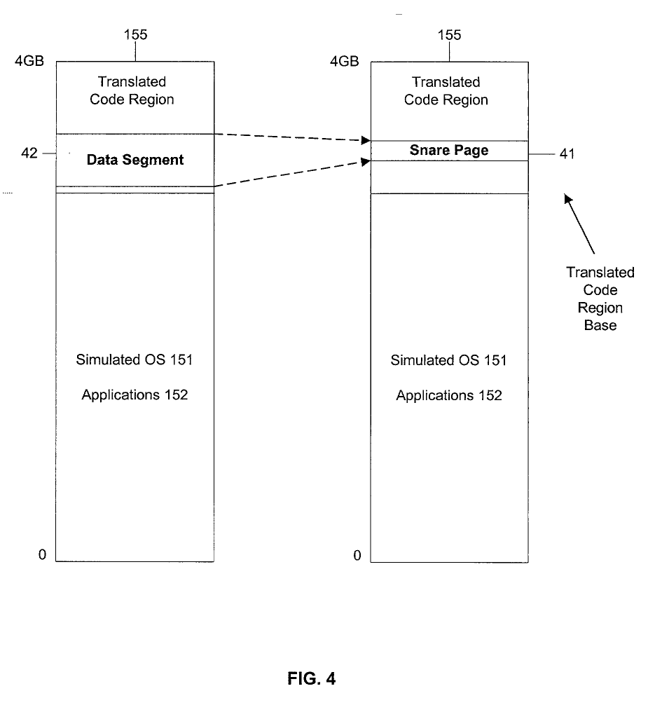

If one of the original data segments is an expand-up segment, and it fully falls in the translated code region 155, any attempt by the directly executed instructions to access this segment should be intercepted. FIG. 4 shows an approach that may be adopted to resolve this situation. If a data segment 42 completely lies in the translated code region 155, the VMM 16 will replace the segment by an artificial segment called a snare page 41, which is a 4 KB page that marked as “not present” in the page tables used by the VM 15. During the execution of the translated guest code, if there is any attempt to access the data in the data segment 42, the access will be translated to a snare page 41 access. The base address for the snare page 41 will be used instead of the original base address.

If an instruction requires a data item in the data segment 42, the location of that data item will be calculated from the offset in the operand. If the offset is smaller than 4 KB, a page fault will be generated. If the offset is greater than or equal to 4 KB, a general protection fault will be generated. In both cases the execution control is passed to the VMM 16, which invokes the auxiliary ISA simulator 162 to simulate the original instruction that causes the fault.

FIG. 3B shows an example of the virtualization of a data segment that completely resides in the translated code region 155. This example assumes that translated code region 155 is based at the linear address 0xF0000000, and the snare page is mapped at 0xFFFF0000.

An expand-down segment is a segment that spans downwards from its base. If one of the original data segments is an expand-down segment, regardless whether the segment partially or entirely overlaps with the translated code region 155, the virtualization algorithm will replace the segment with a snare segment as described above.

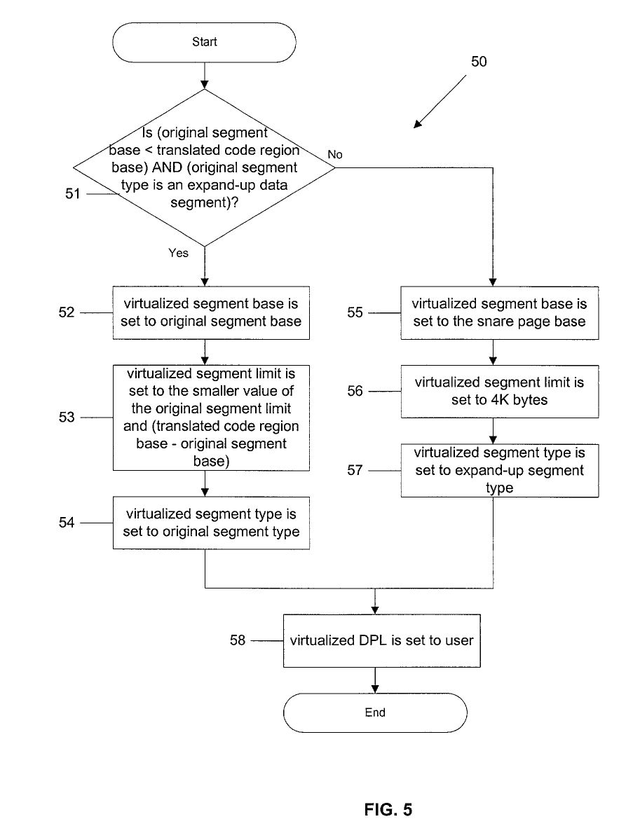

FIG. 5 shows a flow diagram of a virtualization algorithm 50 executed by the VMM 16. A pseudo-code for a virtualization algorithm that implements the process 50 is described below. The pseudo-code includes a function min (A,B) that returns the minimum value of A and B.

if ((original segment base<translated code region base) AND (original segment type is an expand-up data segment)) (step 51)

{

virtualized segment base=original segment base; (step 52)

virtualized segment limit=min (original segment limit, translated code region base−original segment base); (step 53)

virtualized segment type=original segment type; (step 54)

}

else

{

virtualized segment base=snare page base; (step 55)

virtualized segment limit=4 KB; (step 56)

virtualized segment type=expand-up data segment; (step 57)

}

virtualized DPL=user; (step 58)

(End of the algorithm.)

Accordingly, other embodiments are within the scope of the following claims.

What is claimed is:

1. A system for simulating machine instructions on a host machine comprising:
a monitor that translates the machine instructions into translated code and prevents the translated code from being modified;
a virtual machine that executes the translated code stored in memory; and
a kernel that detects exceptions occurring in the virtual machine and transfers control between the virtual machine and the monitor according to a type of the exceptions.

2. The system of claim 1 wherein the host operating system also supports a full platform simulator that includes device models.

3. The system of claim 1 wherein the translated code and the original machine instructions access the memory using the same addresses.

4. The system of claim 1 wherein the monitor further includes an auxiliary simulator that executes the machine instructions.

5. The system of claim 1 wherein the monitor replaces one of the machine instructions with a capsule if the machine instruction accesses a system state of a central processing unit of the host machine.

6. The system of claim 1 wherein the monitor modifies a descriptor table to prevent the translated code from being modified.

7. The system of claim 6 wherein the monitor modifies the descriptor table to remove a portion of the segment that overlaps with the memory storing the translated code.

8. The system of claim 6 wherein the monitor modifies the descriptor table to replace the segment with a substitute segment, which, when accessed, causes an exception to be generated.

9. A method of simulating machine instructions on a host machine comprising:
translating the machine instructions into translated code;
storing the translated code in memory;
executing the translated code;
preventing the translated code from being modified;
detecting exceptions in the execution of the translated code; and
transferring control to an appropriate simulation module on the host machine according to a type of the exceptions.

10. The method of claim 9 further comprising simulating a device.

11. The method of claim 9 further comprising accessing memory by the translated code using the same addresses as the addresses used by the original machine instructions.

12. The method of claim 9 further comprising replacing one of the machine instructions with a capsule if the machine instruction accesses a system state of a central processing unit of the host machine.

13. The method of claim 9 further comprising modifying a descriptor table to prevent the translated code from being modified, the descriptor table including attributes of a segment of the memory.

14. The method of claim 13 further comprising modifying the descriptor table to remove a portion of the segment that overlaps with the memory storing the translated code.

15. The method of claim 13 further comprising modifying the descriptor table to replace the segment with a substitute segment, which, when accessed, causes an exception to be generated.

16. A computer program product residing on a computer readable medium comprising instructions for causing the computer to:
translate the machine instructions into translated code;
store the translated code in memory;
execute the translated code;
prevent the translated code from being modified;
detect exceptions in the execution of the translated code; and
transfer control to an appropriate simulation module on the host machine according to a type of the exceptions.

17. The computer program product of claim 16 further comprising instructions for causing the computer to simulate a device.

18. The computer program product of claim 16 further comprising instructions for causing the computer to access memory by the translated code using the same addresses as the addresses used by the original machine instructions.

19. The computer program product of claim 16 further comprising instructions for causing the computer to replace one of the machine instructions with a capsule if the machine instruction accesses a system state of a central processing unit of the host machine.

20. The computer program product of claim 16 further comprising instructions for causing the computer to modify a descriptor table to prevent the translated code from being modified, the descriptor table including attributes of a segment of the memory.

21. The computer program product of claim 20 further comprising instructions for causing the computer to modify the descriptor table to remove a portion of the segment that overlaps with the memory storing the translated code.

22. The computer program product of claim 20 further comprising instructions for causing the computer to modify the descriptor table to replace the segment with a substitute segment, which, when accessed, causes an exception to be generated.
